(19) United States
(12) Patent Application Publication
(10) Pub. No.: US 2003/0203072 A1
(43) Pub. Date: Oct. 30, 2003

(54) Rehydration beverage

(75) Inventors: John Sean O'Mahony, Clarence, NY (US); Carmen Daniel Pacelli, Carol Stream, IL (US)

Correspondence Address: BANNER & WITCOFF, LTD., TEN SOUTH WACKER DRIVE, SUITE 3000, CHICAGO, IL, 60606, US

(73) Assignee: Team NRG, Inc., Carol Stream, IL

(21) Appl. No.: 10/423,220

(22) Filed: Apr. 25, 2003

Related U.S. Application Data
(60) Provisional application No. 60/375,853, filed on Apr. 26, 2002.

(51) Int. Cl. A23L 1/30

(52) U.S. Cl. 426/72

(57) ABSTRACT

A good tasting rehydration beverage is disclosed that is free of calories and that when consumed during exercise, provides proper rehydration and the correct isotonic concentration to maintain optimum performance and good health. The rehydration beverage also provides the consumer with electrolytes, nutrients, and energy that may be lost during physical exertion, or to those lacking these vital nutrients. The rehydration beverage is free of sugar and carbohydrates and therefore contains no calories.

### RELATED APPLICATION

This application claims priority to U.S. Provisional Application No. 60/375,853 filed Apr. 26, 2002.

### FIELD OF THE INVENTION

The present invention relates to a rehydration beverage for human consumption. The invention is particularly useful before, during, and after physical activity. The present invention also relates to a method of preparing a rehydration beverage by combining the powdered composition of the invention with water, the powdered composition rapidly and completely dissolving in the water to achieve the final blend of the beverage.

### BACKGROUND OF THE INVENTION

It is known that fatigue during prolonged physical activity occurs in response to a combination of dehydration, glycogen depletion and hypoglycaemia. The extent to which of these physiological conditions predominates and limits performance will depend upon the prevailing circumstances. For example, it is understood that fatigue during prolonged exercise in cold environments occurs as a result of inadequate energy (carbohydrate) availability. While, prolonged exercise in hot environments results in hyperthermia due to dehydration.

It is equally well known that the use of isotonic beverages, such as sports drinks or energy drinks, containing both electrolytes and carbohydrates, are consumed either before or during exercise to improve performance. These known beverages, which have been developed over the past thirty years, claim to provide energy and replace carbohydrates, electrolytes, vitamins, minerals, amino acids, and other nutrients which are lost during physical activity. Nearly all of these beverages are modeled after the original Gatorade® brand sports drink developed in the 1960's. However, these known beverages while providing desired electrolytes and minerals include high concentrations of sugars, carbohydrates and calories. For people trying to lose weight through exercise, the high concentrations of sugars, carbohydrates and calories are undesirable. The present invention is directed at overcoming these and other known problems associated with prior art high-calorie isotonic beverages.

### BRIEF SUMMARY OF THE INVENTION

The present invention discloses a good tasting rehydration beverage that when consumed during exercise, provides proper hydration and the correct isotonic concentration to maintain optimum performance and good health. The beverage of the present invention also provides the consumer with electrolytes, nutrients, and energy that may be lost during physical exertion, or to those lacking these vital nutrients. The beverage offers a cleaner taste than known isotonic beverages and has no negative aftertaste. Significantly, the present invention is free of sugar, carbohydrates and calories.

The beverage of the present invention may be provided in either liquid form or powdered form that when reconstituted with water is a good tasting and refreshing rehydration beverage.

### DESCRIPTION OF THE INVENTION

In an exemplary embodiment, the present invention is a zero calorie isotonic beverage that may be embodied in various forms, flavors and compositions, depending on the desired taste and performance. Multiple exemplary embodiments of the invention are detailed below and include, but are not limited to, the following components that are reconstituted or mixed with water: citric acid, sodium chloride, sodium citrate, monopotassium phosphate, sucralose, Vitamin C, and fruit flavoring and coloring. It should be understood that these components may be combined in various proportions, and that additional components may be added, including vitamins, minerals, amino acids and neutriceuticals, as described below. The resulting beverage provides the consumer with proper hydration and isotonic concentration for optimal performance, while being free of sugar and carbohydrates, which provide the consumer with undesirable calories.

More specifically, in an exemplary embodiment, the present invention includes the following components having the following component percentages. Citric acid is present at concentrations of approximately 42% to 50%. Sodium chloride is present at concentrations of approximately 16% to 20%. Sodium citrate is present at concentrations of approximately 12% to 16%. Monopotassium phosphate is present at concentrations of approximately 3% to 10%. Sucralose is present at concentrations of approximately 1% to 5%. Vitamin C is present at concentrations of approximately 0.5% to 1.5%. The balance of the beverage includes flavoring and coloring. It should be understood that variations to the above concentration ranges for the beverage of the invention are possible depending on the desired performance requirements for the beverage and the desired overall taste.

Even more specifically, Tables 1 and 2 illustrate exemplary embodiments of a typical fruit punch powdered composition of the present invention. The composition set forth in Table 1 is provided in terms of batch weight, with the batch weight being approximately 93 pounds.

TABLE 1

| INGREDIENTS | Weight (pounds) | Percent |
|---|---|---|
| Citric Acid | 43.5 | 46.7 |
| Sodium Chloride | 17.3 | 18.6 |
| Sodium Citrate | 14.4 | 15.5 |
| Fruit Punch Flavor | 10.1 | 10.9 |
| (D 0090861) | | |
| Monopotassium Phosphate | 3.6 | 3.9 |
| Splenda ® brand sucralose | 2.9 | 3.1 |
| Fruit Punch Color | 0.4 | 0.4 |
| (DB-1068) | | |
| Vitamin C | 0.8 | 0.9 |
| Total | 93 | 100 |

The exemplary composition set forth in Table 2 is also provided in terms of batch weight, with the batch weight being approximately 380 pounds.

TABLE 2

| INGREDIENTS | Weight (pounds) | Percent |
|---|---|---|
| Citric Acid | 170 | 44.7 |
| Sodium Chloride | 68 | 17.9 |
| Sodium Citrate | 56.6 | 14.9 |
| Fruit Punch Flavor | 39.5 | 10.4 |
| (D 0090861) | | |
| Monopotassium Phosphate | 29.6 | 7.8 |
| Splenda ® brand sucralose | 11.4 | 3 |
| Fruit Punch Color | 1.5 | 0.4 |
| (DB-1068) | | |
| Vitamin C | 3.4 | 0.9 |
| Total | 380 | 100 |

Tables 3 and 4 illustrate exemplary embodiments of a lemon lime powdered composition of the present invention. The exemplary composition of Table 3 is provided in terms of batch weight, with the batch weight being approximately 93 pounds.

TABLE 3

| INGREDIENTS | Weight (pounds) | Percent |
|---|---|---|
| Citric Acid | 44.1 | 47.4 |
| Sodium Chloride | 17.7 | 19.1 |
| Sodium Citrate | 14.7 | 15.8 |
| Lemon Lime Flavor | 8.8 | 9.5 |
| (D 0090860) | | |
| Monopotassium Phosphate | 3.6 | 3.9 |
| Splenda ® brand sucralose | 2.9 | 3.1 |
| Lemon Lime Color | 0.4 | 0.4 |
| (DB-1650) | | |
| Vitamin C | 0.9 | 0.8 |
| Total | 93 | 100 |

The exemplary composition of Table 4 is also provided in terms of batch weight, with the batch weight being approximately 380 pounds.

TABLE 4

| INGREDIENTS | Weight (pounds) | Percent |
|---|---|---|
| Citric Acid | 172.5 | 45.4 |
| Sodium Chloride | 69.2 | 18.2 |
| Sodium Citrate | 57.4 | 15.1 |
| Lemon Lime Flavor | 34.6 | 9.1 |
| (D 0090860) | | |
| Monopotassium Phosphate | 30 | 7.9 |
| Splenda ® brand sucralose | 11.4 | 3 |
| Lemon Lime Color | 1.5 | 0.4 |
| (DB-1650) | | |
| Vitamin C | 3.4 | 0.9 |
| Total | 380 | 100 |

The above-illustrated embodiments are provided in individual 3.35 gram powder-filled packets with each packet being mixed with approximately 20 fluid ounces of water to achieve the beverage of the present invention. It should be understood by those skilled in the art that the above embodiments and weight percentages may be varied, and various flavorings and colors added, and still achieve an object of the present invention, namely, providing a zero-calorie isotonic beverage that provides the proper balance of hydration and electrolytes, without providing sugars or carbohydrates and the undesirable calories.

As shown from the above tables, each of the illustrated embodiments contain sodium and potassium at levels necessary to maintain the blood balance of these critical performance ions. The above embodiments also contain Vitamin C, which is a vitamin known for its antioxidant activity on stressed cellular components. In addition, a non-nutritive sweetener, preferably Splenda® brand sucralose, is used that has no restrictions or negative effects when consumed, in contrast to other non-nutritive sweeteners, which require the use of disclaimers, including the phenylketonurics disclaimer.

In an exemplary embodiment, the ingredients of the above embodiments are combined and blended for 10-15 minutes, through the use of a V or Ribbon type blender, until the color additive is dispersed. The blended powder should be free of lumps.

As stated, the beverage of the present invention may be provided in a liquid or ready to consume form, preferably in quantities of approximately 20 ounces. Alternatively, the beverage may be provided in a powdered or concentrate form that may be reconstituted with water, again approximately 20 ounces, to achieve the isotonic beverage of the invention. Importantly, the inventive isotonic beverage, when consumed, maintains correct blood volume under heavy exercise conditions to maintain optimum performance and good health without providing the undesirable calories.

The benefits of the present invention may be realized in numerous environments by numerous type of consumers where hydration and proper isotonic balance is important. For example, the benefits of the isotonic beverage of the invention may be realized by flight travelers on long flights or other travelers who sit for extended periods of time. Recent reports of dehydration by flight travelers have led to serious illnesses and occasional deaths due to Thrombosis and blood clots of the lower extremities. The latter is a severe condition caused by sitting too long and aggravated by low blood volume and dehydration. The present invention may be consumed by these travelers to assist in preventing dehydration and the resulting harmful effects of dehydration. One of skill in the art will readily appreciate that other beneficial uses and benefits of the present invention exist.

It should be understood that the present invention may be fortified with additional vitamins, minerals, amino acids and neutriceuticals. Pediatric and/or geriatric consumers may require different levels and types of vitamins and minerals, which may be added to the isotonic beverage of the present invention. It is contemplated that vitamins such as B complex, Folic acid, Niacin, Vitamin E, tocotrienols, and Vitamin D, or any other combinations may be added to the isotonic beverage for particular groups of consumers. It is contemplated that additional minerals may be added, including zinc, selenium, chromium (in the form of chromium picolinate), copper and magnesium. Moreover, the present invention may also include other neutriceutical ingredients such as Echinacea, creatine, carnitine, lutein, lycopene (a tomato pigment known for its prevention of breast and prostate cancers and commercially available under the trade name Lyc-o-Mato), St. John's wort, ginseng, phytosterols, lactoferrin, and Serotain (used as an appetite suppressant), glucosamine (for improving joint and bone health), and chondroitin. Amino acids such as L-taurine, glutamine, isoleucine, leucine, valine and L-theanine (an amino acid found in green tea) can also be added. One of skill in the art will understand that other vitamins, minerals, amino acids and neutriceuticals exist and may be added as desired to the present invention.

One of skill in the art will also appreciate that the variety of vitamins, minerals, amino acids and neutriceuticals that may be added will enable the development of categories of isotonic products. Each category may be designed for specific diseases, activities, or athletics that will enable the body to recover quicker and more completely from the stress of that particular activity or disease without contributing undesirable calories or excess sugars. In addition, the present invention can positively contribute to the health of people who suffer from obesity by providing a good tasting beverage containing essential vitamins and minerals without the calories.

While the invention has been described with respect to specific examples of embodiments including presently preferred modes of carrying out the invention, those skilled in the art will appreciate that there are numerous variations and permutations of the above-described embodiments that fall within the spirit and scope of the invention.

What is claimed is:

1. A beverage composition that may be mixed with water, the beverage composition in terms of weight percentage comprising:
approximately 42% to 50% of citric acid,
approximately 16% to 20% of sodium chloride,
approximately 12% to 16% of sodium citrate,
approximately 3% to 10% of monopotassium phosphate,
approximately 1% to 5% of sucralose, and
the balance including Vitamin C, flavoring and coloring,
wherein the composition is free of sugars and carbohydrates.

2. The beverage composition of claim 1 wherein the citric acid is present at a concentration of approximately 44% to 47%.

3. The beverage composition of claim 2 wherein the sodium chloride is present at a concentration of approximately 17% to 19%.

4. The beverage composition of claim 3 wherein the sodium citrate is present at a concentration of approximately 14% to 16%.

5. The beverage composition of claim 4 wherein the monopotassium phosphate is present at a concentration of approximately 7% to 9%.

6. The beverage composition of claim 5 wherein the sucralose is present at a concentration of approximately 3%.

7. The beverage composition of claim 6 wherein the Vitamin C is present at a concentration of approximately 0.5% to 1.5%.

8. The beverage composition of claim 1 wherein the beverage composition is mixed with approximately 20 ounces of water.

9. The beverage composition of claim 8 wherein the composition is provided in packets containing approximately 3.35 grams of the composition.

10. The beverage composition of claim 1 further including an additional vitamin component, the vitamin component selected from the group consisting of B complex, Folic acid, Niacin, Vitamin E, tocotrienols, and Vitamin D.

11. The beverage composition of claim 1 further including an amino acid component, the amino acid component selected from the group consisting of L-taurine, glutamine, isoleucine, leucine, valine and L-theanine.

12. A zero calorie aqueous beverage composition in terms of weight percentage comprising:
approximately 46% to 47% of citric acid,
approximately 18% to 19% of sodium chloride,
approximately 15% to 16% of sodium citrate,
approximately 3% to 8% of monopotassium phosphate,
approximately 3% to 4% of sucralose,
approximately 0.5% to 1.5% of Vitamin C, and
approximately 9% to 10% flavoring,
wherein the beverage composition is mixed with water.

13. The aqueous beverage composition of claim 12 wherein the beverage composition is mixed with approximately 20 ounces of water.

14. The beverage composition of claim 13 wherein the composition is provided in packets containing approximately 3.35 grams of the composition that may be reconstituted with the water.

15. The beverage composition of claim 12 further including an additional vitamin component, the vitamin component selected from the group consisting of B complex, Folic acid, Niacin, Vitamin E, tocotrienols, and Vitamin D.

16. The beverage composition of claim 12 further including an amino acid component, the amino acid component selected from the group consisting of L-taurine, glutamine, isoleucine, leucine, valine and L-theanine.

17. The beverage composition of claim 12 further including a mineral component, the mineral component selected from the group consisting of zinc, selenium, chromium, copper and magnesium.

18. A method of preparing an beverage comprising the steps of:
(a) preparing a mixture of beverage composition blend comprising in terms of weight percentage approximately 42% to 50% of citric acid, approximately 16% to 20% of sodium chloride, approximately 12% to 16% of sodium citrate, approximately 3% to 10% of monopotassium phosphate, approximately 1% to 5% of sucralose, and the balance including flavoring and coloring; and
(b) mixing the beverage composition blend with water to produce an ingestible beverage.

19. The method of claim 18 wherein the mixture further includes a mineral component and an amino acid component.

20. The method of claim 18 wherein the mixture further includes a neutriceutical component, a vitamin component, and an amino acid component.
